(19) United States
(12) Patent Application Publication
(10) Pub. No.: US 2007/0276715 A1
(43) Pub. Date: Nov. 29, 2007

(54) Distributed activity management

(76) Inventors: Joerg Beringer, Los Altos, CA (US); Dennis B. Moore, Hillsborough, CA (US)

Correspondence Address: SAP/BLAKELY, 1279 OAKMEAD PARKWAY, SUNNYVALE, CA, 94085-4040, US

(21) Appl. No.: 11/803,760

(22) Filed: May 15, 2007

Related U.S. Application Data
(60) Provisional application No. 60/800,919, filed on May 15, 2006.

(51) Int. Cl. G06F 17/50

(52) U.S. Cl. 705/7

(57) ABSTRACT

Methods and apparatuses enable generating distributed workflows that couple actions with a business scenario, and relate activities to each other with request-to-perform (RTP) relationships. The activities are coupled to the business scenario to generate a workflow, and the RTP relationships enable management of distributed activities that are part of the workflow. Individual actions and activities that are part of a business objective are modeled. The modeled actions define resources related to a business activity. The individual activities can be instantiated and related with RTP relationships to result in a workflow that can be generated and managed by the enterprise system. Interactions between users can be captured within the system as part of the workflow. In one embodiment, distributed workflows operate within traditional fixed (e.g., ERP) workflows, for example, by modeling complex tasks of a fixed workflow that actually requires multiple actions before being completed.

This U.S. patent application claims priority to U.S. Provisional Patent application No. 60/800,919 filed May 15, 2006.

### FIELD

Embodiments of the invention relate to workflow management, and more particularly to management of distributed activities of workflows.

### BACKGROUND

Work within an enterprise or company is frequently performed within the framework of a business process or a workflow having a business objective. The workflow traditionally has multiple phases or states, where business activity is required for each state. When the business activity has been performed by the user, the workflow can traditionally progress to the next phase or state where more business activity will occur. Business systems have been established to generate and manage workflows within the enterprise. A variety of tools are available for establishing and monitoring traditional workflows.

Traditional workflows have all been ERP (Enterprise Resource Planning)-centric. That is, workflows as previously established were focused around systems. ERP systems were created and put into place, and users were required to think and act around the system in order to accomplish their work. Such requirements result in user inefficiencies. Many times a user has to perform extra requirements or engage in significant “busy work” to appease the system design and perform the phase of the business process. Enterprise systems monitor and manage the workflows, and generally required data and input in a specific format and/or of a specific type to be able to monitor the work done. ERP-centric workflow monitoring is most effective when a simple “approve” or “disapprove” is required to “complete” the workflow state. However, many business processes have phases of work that require an “output” or a work product. Such business process phases may be complex in terms of what is required of the user, and yet it will appear within the system as a phase equal to any other within the business process. Thus, a phase for an user to generate a proposal, and a subsequent phase to have the manager approve or disapprove may be considered equal within the system, even though generating the proposal may require much more in terms of business actions to generate.

In addition to the inefficiencies of conforming to the workflow designed around the system, the enterprise systems are traditionally unable to monitor the separate actions that make up a workflow state. Following on the example above, if a phase of a workflow requires a user to generate a proposal, there may be several actions required of the user, which may include interaction with several other users. Traditional systems have no mechanism to deal with the individual actions of a user that executes a phase of a workflow. Thus, the individual actions of the user are historically “invisible” to the system, which cannot model or manage such actions. Any interaction between the user and another user are similarly not part of the workflow as far as known systems are concerned.

Thus, current workflow systems create inefficiencies in imposing on users a system to follow that may or may not represent the natural flow of work. Additionally, the individual actions of users and the interactions of users with regard to a phase of the workflow are invisible to the system, which cannot generate tasks or activities to represent such actions, and cannot manage and record the interactions.

### SUMMARY

Systems and methods enable distributed workflows that focus on human activities related to a business objective. The individual actions that represent work activities can be captured, generated, and managed by the enterprise system. The activities of multiple contributors within the distributed workflow are modeled as a business scenario that relates the activities to each other in the form of request-to-perform (RTP) relationships that couple the activities together. In one embodiment, distributed workflows are used to supplement fixed workflow (e.g., traditional ERP-centric workflows). Thus, a distributed workflow can be used to model individual activities required to accomplish a phase of a fixed workflow. The fixed workflows that are already in place in an enterprise need not be replaced, but can be extended by using distributed workflows to capture the individual actions that are to be performed by the enterprise user. Distributed workflows could also be used independently of fixed workflows.

According to one implementation, a system stores distributed workflow templates in a backend system (design-time components) to be instantiated (runtime components) for a specific work activity. The distributed workflow templates can be generic enough to be instantiated for any of a number of different activities to be performed by one or several users. Each activity may include a number of different actions that may or may not require user interactions. In one embodiment, a development environment is provided that generates a distributed workflow template to be stored in a backend enterprise system. A specific instance of the distributed workflow can be generated from the template for a complex task of a workflow (e.g., a task that would require multiple user actions). The distributed workflow template includes an activity context that can contain multiple actions and resources associated with the complex task, which can be assigned values when the distributed workflow is instantiated. Each activity of the distributed workflow can be considered a state or phase of the workflow, each interrelated with other activities or states via a request-to-perform relationship. Thus, a request-to-perform control can be used by the system to manage the workflow.

According to one implementation, a system generates a fixed workflow from a template. The fixed workflow, such as an ERP workflow, has a series of tasks or states. At least one of the tasks is a complex task that has multiple actions that complete the task. The fixed workflow is managed with transactional control, where the completion of a task causes the system to enable the next task in the workflow. The system generates a distributed workflow for the complex task, where each of the activities of the complex task are modeled and associated with request-to-perform control. The system monitors the workflows according to their individual flow control. That is, the fixed workflow is monitored according to the transactional control, and the distributed workflow is monitored according to the request-to-perform control. Monitoring can include recording and tracking in the backend enterprise system data resulting from the interactions of the activities and the actions of the activities.

According to one implementation, a system models a business process by generating a distributed workflow. The system generates individual templates for individual actions of an enterprise business activity, the templates including parameters configurable to define resources related to the business activity. The system further assigns a request-to-perform relationship between two actions, which relates the actions as consecutive phases of a workflow. The system stores the templates and the assigned relationship, which can then be instantiated as a distributed workflow for one or more tasks of a business process.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system with a fixed workflow having a task that includes multiple actions.

FIG. 2 is a block diagram of an embodiment of a system for generating fixed and distributed workflows.

FIG. 3 is a block diagram of an embodiment of a system with an activity management entity that monitors activities generated with a request-to-perform control.

FIG. 4 is a flow diagram of an embodiment of a process for requesting and performing as part of a managed workflow.

FIG. 5 is a block diagram of an embodiment of a system that generates and monitors a distributed workflow.

FIG. 6 is a flow diagram of an embodiment of a process for generating a workflow having request-to-perform relationships defining workflow state changes.

FIG. 7 is a flow diagram of an embodiment of a process for generating fixed or distributed workflows.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Methods and apparatuses enable the modeling of distributed workflows that orchestrate activities of one or several users into a business scenario, and relate such activities to each other with request-to-perform (RTP) relationships. The actions are coupled to the business scenario to generate a workflow, and the RTP relationships enable management of distributed activities that are part of the workflow. Individual actions that are part of a business objective of an activity can be modeled. Activities and actions can be modeled with respect to resources and services that are consumed and generated. The individual activities can be instantiated and related with RTP relationships to result in a workflow that can be generated and managed by the enterprise system. Interactions between users and actions of one user can be captured within the system as part of the workflow. In one embodiment, distributed workflows operate in conjunction with traditional fixed (e.g., enterprise resource planning (ERP)) workflows, for example, by modeling complex tasks of a fixed workflow that actually requires multiple user activities before being completed.

Traditional transactional applications and ERP-centric workflow models are not technologically equipped to support enterprise services architecture (ESA) or multi-channel, multi-modal occasionally connected (OCA) user experience. Traditional workflow only works for very simple tasks such as: “provide an approval,” after which the system can continue to execute the workflow. When tasks are more complex, which is increasingly common, the additional actions a user performs to “complete” the task are not traditionally part of the workflow model.

With ESA, business applications are closer to a bundle of resources than a monolithic transaction or application. Thus, workflow that focuses on transactions rather than services and resources results in inefficiencies. In contrast to traditional monolithic transaction-based workflows, enterprise services can be composed into granular user actions that serve as reusable building blocks when modeling activities within a distributed workflow. Rather than writing an application, the developer generates short process descriptions and attaches available services and business actions to the process description. An activity within the distributed workflow model is created by assembling actions together.

In one embodiment, the distributed activity management can be considered to have two components: a service-oriented Activity Model that defines a relationship of an activity to a business scenario; and, an Event Model that defines an RTP relationship between activities. The Activity Model allows actions to be generated as components or building blocks that can define individual actions or operations that will be performed by a user in context of one activity. The activity can have an extended context describing typical performers, pre-conditions, required resources, core actions, related information, related resources, accept and declare options, business rules, task classification, etc., which can be dynamically assigned to an individual action and related to the business scenario. The distributed Activity Model describes business processes by means of definitions or descriptions that couple activity-centric contexts that are connected to a Scenario that serves a specific business intent. The Event Model defines events as requests-to-perform (RTPs). In one embodiment, the Event Model includes annotations (e.g., metadata) that identify a work Requester and a work Performer in any transaction.

The Event Model further supports ad-hoc conversations and acceptance terms among the Requester and Performer. That is, collaboration between the Requester and Performer can become part of the model from which workflows are created. The Event Model allows building an ad hoc coordination between the requester and the performer. The ad hoc coordination can reduce the complexity of flow models while still allowing for typical ad hoc conditions of state transition in the workflow based on negotiation between the requester and performer. Thus, state transitions can occur and ownership of activities can transfer within a workflow due to negotiation or other collaboration between requester and performer. The RTP relationship can thus be ad hoc, allowing dynamic activity to be modeled within the system.

By modeling business processes as a collection of loosely coupled individual contributions of individuals, the control structure of the distributed workflow more closely resembles the actual work practice of enterprise users. In one embodiment, business workflow and person-to-person work procedures are brought together, seeing that the same data model and technology can be used to model fixed workflows (business workflow) as well as distributed workflows by modifying the requester-performer relationship and the conditional actions. The same technology can also be used to handle system or human requests. The same technology can also be used to model simple activities consisting of a single task or complex activities consisting of tasks including sub-activities. Distributed workflows could also be integrated with traditional fixed workflows.

Additionally, distributed workflows allow contextual collaboration in person-to-person work processes. Solutions for human activities can be provided as enterprise solutions to support more flexible and ad-hoc human activities. Procedures that are currently “hidden” within an enterprise could be surfaced and streamlined, and checked for compliance and efficiency. Including people processes into business processes enables the handling of exceptions and less structured work at a system level.

Thus, distributed activity management provides a model-driven workflow using a request-perform control structure that puts distributed collaborative activities into a coherent context related to a business goal. The distributed activity model describes business processes by means of loosely coupled activity-centric context models, and connects such models to scenarios that serve a specific business intent.

According to the teachings herein, an enterprise system can model a business process on multiple layers. In one embodiment, a business process is modeled on three layers: Scenario, Activity (task), and Action. A scenario layer exists on a first level, where a developer lays out the activities of users, and connects activities of one or several users through an event-driven control flow, such as RTP relationships. Thus, in one embodiment, every activity has a requester and a performer. Requests can be simply accepted and acted on, or the performer can ask for additional details or enter negotiations with the requester. The scenario description may include a role description for the performer of an activity that profiles the performer with respect to skills, organizational role, relationships to other performers, or simply the name of the user. The role definition facilitates the scenario and a resulting business process to be dynamic. Rather than inputting a particular person into the business process, the business process can be defined in terms of a role, or a “type” of person that can/should perform a particular action. When the business process is instantiated, the system can place an actual person into the workflow.

Scenarios are composed by defining activity blocks, assigning them to process roles, and linking them through requests. Each activity is triggered by a request, which may be either a system event or human request. Resources from the scenario context are handed over to activities as required resources. As used herein, resources refer to elements that may be used to perform a work action. Examples may include a business object (a vendor, an invoice), a document (a statement of work (SOW)), an interactive form (ISO certification questionnaire), people, a report, etc. Ad-hoc conversations between requester and performer are supported and optionally captured as a conversation thread.

An Activity Model within a scenario is modeled as a separate entity describing an actionable business context interfacing with the scenario via events. A request event triggers an activity that models personal contributions in the form of a context description that defines potential actions, resources, rules, and related information associated with the activity. The activity may also include requests to other contributors to perform certain activities. An activity can further be split into separate actions that accomplish a task. As used herein, a task refers to a phase of a workflow. A task is some work or action (which could be an Action as described below), or something to do or accomplish. Tasks may be the subject of requests. An activity block is a collection of actions, information, and related resources that one user needs to accomplish the requested task. Each activity block may provide guidance for individual performers in terms of what actions to perform, and the checking of preconditions, required resources, and business rules. Each activity can be enriched to offer related information and actions. The system can also model activities recursively, so that a request within one activity can trigger sub-activities or entire new work situations (scenarios).

An Action is a reusable atomic building block for meaningful business acts. An action provides a high-level enterprise service that encapsulates services and a user interface (UI). In one embodiment, actions provide a plug-and-execute interface to the activity context. In one embodiment, an action is a non-transactional view of a work item. Actions can provide the UI for supporting user interaction. Actions as reusable building blocks can be used to construct complex activities of a distributed workflow. Actions are connected to the enterprise backend (ESA), and may contain embedded navigation (e.g., object links, multiple screens such as guided activities). Examples of actions might be: Post Message, Create PO, Approve Vendor, View Supplier Details, View 360 supplier review, Create Vendor Record, Request Missing Document, Choose Between Candidates, Evaluate Candidate, Submit Application, Set New Salary, Promote Employee, Create Invoice, etc., or anything that can be perceived as an atomic work action from a business perspective. Thus, actions will likely be different in different implementations, seeing that different enterprises/organizations may view the atomic level of actions differently.

To capture, generate and execute distributed workflows, the enterprise system includes design-time and runtime components. Details of each are described below. Regarding design-time components, simplified design times enable business experts to model scenarios and activities. Scenarios that already exist within an enterprise can serve as templates for new processes. Reusable actions enable business experts to configure an activity without implementing any service or UI. The design-time components are embodied in a design-time engine, which may include separate components (e.g., separate modules), or may include the functionality of each of the below. In one embodiment, a Process Map diagram component or function is used to lay out processes. Such a process map is described in co-pending U.S. patent application Ser. No. ______, entitled, “Business Process Map Management,” having the same corporate assignee, and filed concurrently herewith. Such a process map diagram lays out roles across “swim lanes,” and displays activities and their associated requests along those swim lanes. The swim lane provides a simple mechanism for orchestrating the activities of multiple performers, and then converting them by the system into a distributed workflow model. To include system generated events and activities, a swim lane can also represent services or business objects that are controlled by system applications and workflows.

In one embodiment, the design-time engine includes or embodies an Activity Composer, which can be used to compose all actions required to accomplish an activity. Activities and actions can be enriched with contextual information. The Process Map can be used to link activities from several people via RTP events. The Activity Composer can be used to model individual activities. This clear distinction helps business experts to focus on either the process scenario level or the personal task flow level. The Activity Composer allows a designer to pull together specific services into the activity to enable a user to perform actions via the services.

In one embodiment, the design-time engine includes or embodies an Activity Broker that determine whether a particular action can be displayed/accessed via a particular device, and if so, in what mode. The Activity Broker can enable support for multi-channel and OCA runtimes. The information about modes and channels can be provided directly in the activity through metadata or activity parameters.

In one embodiment, activities and actions are annotated. For example, activities can be annotated with respect to task complexity on a scale from problem solving to simple approval. Actions can be annotated with respect to UI requirements such as needs a large (relatively) display or, can be done via voice. Actions can also be annotated with respect to availability of service, for example, real-time, offline, OCA. Together with personal preferences these annotations allow for smart dispatching, previewing, and execution of activities in multiple devices. Such annotations can exist via metadata associated with the activity and/or action.

Regarding the runtime components, the runtime can be generally considered to be provided by a runtime engine, which includes various components (e.g., modules) or embodies the functionality. The runtime provides progressive access to business context and functions of the distributed workflow. Requests can be managed on any device. Users (workers) can preview activities by checking the existence of required resources, and the fulfillment state of pre-conditions. The users can preview their own activities by looking into the list of modeled actions of an activity. The execution of one of those actions, or the viewing of resources and related information depends on the device capabilities and the match of task complexity to current mental load of the user. The current mental load of the user can be inferred or derived by context-awareness based on device, location, and work situation.

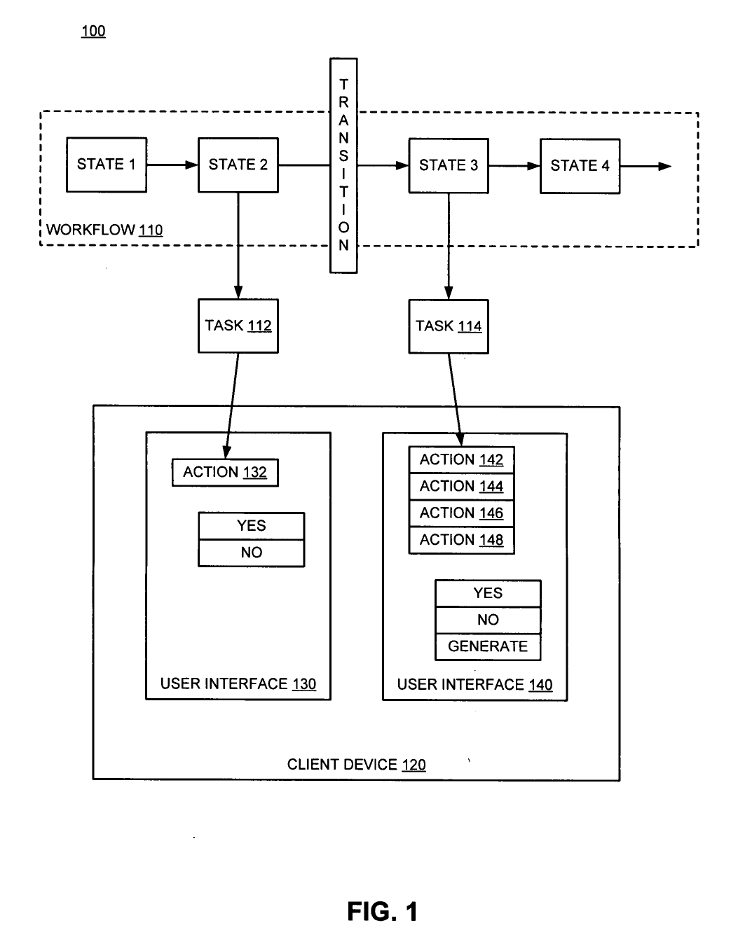

FIG. 1 is a block diagram of an embodiment of a system with a fixed workflow having a task that includes multiple actions. System 100 represents an enterprise system that includes client device 120, and workflow 110. Workflow 110 is an application or an enterprise system control structure that is typically executed from a backend enterprise system. One or more components of workflow 110 could be executed locally on client device 120; however, workflow 110 will generally be considered to be executing on a system level via business logic and enterprise services available from the backend system.

In one embodiment, workflow 110 represents a fixed or transactional workflow, which is a workflow that is defined as a whole system, and states or phases of the workflow are generated to fill out the system. Contrast such a top-down approach with the more bottom-up definition of a distributed workflow as described herein, where multiple activities are defined, and are then coupled together in a workflow for a business scenario. Workflow 110 includes states 1-4, which represent different transactions of the workflow. Each state can be simple, such as “provide approval for the budget,” to something more complex, such as, “interview top candidates.” Note that four states are shown for purposes of simplicity, and it is possible, and may be common, for workflows to have many more phases.

Consider the transition illustrated between state 2 and state 3. Similar transitions occur between all states, and only the transition between states 2 and 3 is shown. Specifically, in a fixed workflow, the transition is controlled via a transaction model where a user completes the “transaction” required for the particular state, and may provide information to the system for the state. Once the state is completed, the user can so indicate the completion to the system, which then allows the states to transition. In such a control model, interactions between users is typically not part of the system model and control, nor can “ownership” or responsibility for a particular state change according to different actions that need to occur to complete the transaction.

As illustrated, state 2 is represented by task 112, which is a business activity or some work that needs to be accomplished, or some business action or group of actions that needs to be performed towards the final achievement of completing the business process represented by workflow 110. Similarly, task 114 represents the business activity of state 3. In one embodiment, task 112 is a simple task that may have only a single action, action 132, which needs to be performed to complete the task. In contrast, task 114 is a complex task that has multiple actions, actions 142-148, which need to be accomplished to complete task 114. For example, task 112 and consequently action 132 can be completed with a simple yes or no as illustrated in user interface 130. In contrast, task 114 requires the completion of actions 142-148 that may not only involve one or more yeses or nos, but also a “generate,” which requires producing something for the business process (e.g., a document, a report, etc.).

Note that task 112 is represented in user interface (UI) 130, and task 114 is represented in UI 140. In practice, UI 130 and UI 140 may be the same user interface. They may alternatively be components of the same interface (e.g., windows, panes, fields, etc.). Alternatively, they may be separate interfaces, each rendered separately. In one embodiment, task 114 is not displayed until task 112 is completed. Task 112 and task 114 may also be the responsibility of different users, which would mean that different users would receive the UIs 130 and 140.

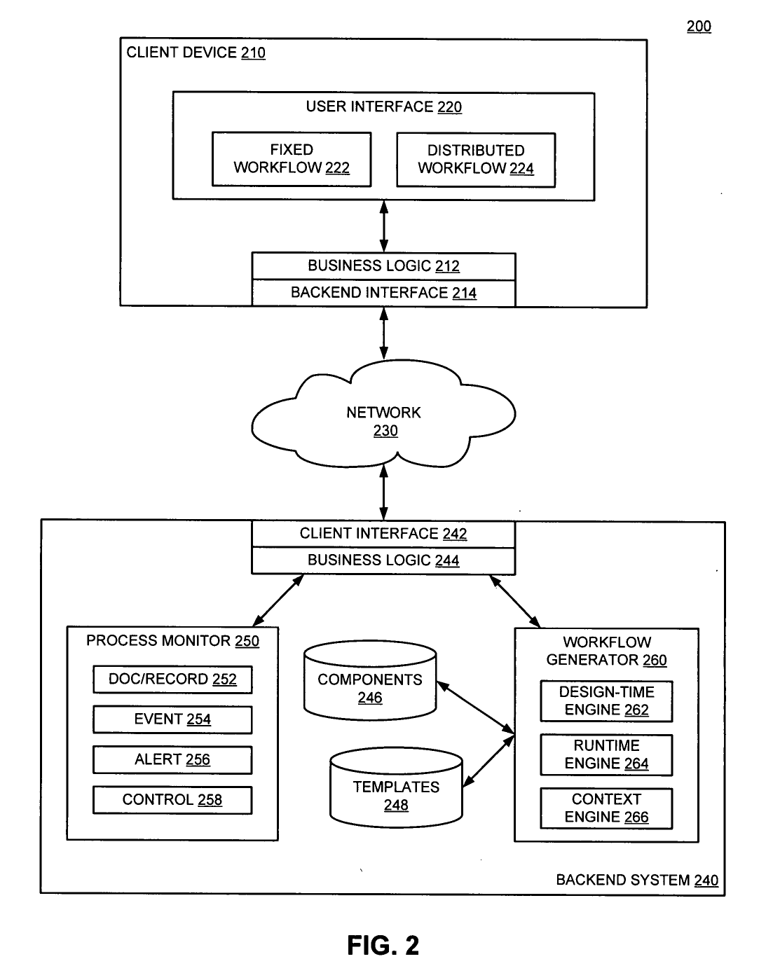

FIG. 2 is a block diagram of an embodiment of a system for generating fixed and distributed workflows. System 200 includes client device 210 and backend system 240. Client device 210 represents any of a number of devices with which a user may interface with a workflow. Examples include, but are not limited to, desktop computers, laptop computers, mobile phones, handheld wireless devices, etc. Client device 210 includes user interface 220, which represents one or more input and output components that enable a user to interact with an item represented in the UI. UI components may include touchscreens, displays, keypads, etc. In one embodiment, UI 220 is able to represent fixed workflow 222 and distributed workflow 224 within system 200. That is, system 200 may support both fixed and distributed workflows. As mentioned above, workflows that are traditionally fixed can be generated with the same technology used to generate distributed workflows. Additionally, distributed workflows can be generated which model business processes not previously available in enterprise systems.

Distributed workflow 224, and possibly fixed workflow 222, is a representation of a bundle of enterprise resources, such as document or business object resources, as well as enterprise services that enable access to backend functionality and enterprise business objects. In one embodiment, at least a portion of the functionality presented via distributed workflow 224 is enabled via business logic on the enterprise system (business logic 244). Additionally, client device 210 may include business logic 212 that provides connection functionality and enables use of the services from client device 210. In one embodiment, business logic 212 represents runtime components that may be executed from client device 210. Other runtime components are executed in backend system 240, and may be represented by business logic 244.

Client device 210 includes backend interface 214, which may be a general-purpose network connection device, such as a network interface card, a wireless (e.g., WLAN) or cellular circuit, etc. Backend interface 214 connects to backend system 240 via network 230, which represents any type of network or combination of networks. For example, network 230 may be a wired local area network (LAN), a wireless LAN (WLAN), a cellular communications system, etc. Backend system 240 is coupled to network 230 via client interface 242, which enables backend system 240 to interface with client devices including sending and receiving information related to workflows.

Backend system 240 represents one or more enterprise servers, databases, etc. In one embodiment, backend system 240 includes process monitor 250, which represents one or more modules or components that manage workflows. Process monitor 250 may include, for example, modules for generating or storing a document or record 252, for producing an event 254, for generating a system alert 256, and for generating a system control 258. Record 252 represents any type of system storage of a task. The storage may be in the form of data in a field of a database, a document, a file, etc. Event 254 represents system operations that may take place as a result of work on a workflow activity. Events may include anything from scheduling to shipping to generating a task for another user. Alert 256 represents a mechanism within backend system 240 that can provide information to one or more users regarding a workflow or an activity or action of a workflow. Alerts can be produced on a schedule (e.g., daily, weekly), as well as occurring when an action occurs, when a state change happens, etc. Control 258 represents any other type of control, system signal, command, error, etc., which may be generated by backend system 240 via process monitor 250 in response to something happening or not happening (that should be happening) on a workflow.

Backend system 240 also includes workflow generator 260, which represents components that generate workflows. Workflows as described herein include various aspects—design-time components include templates and building blocks that represent the workflow and its constituent elements (e.g., activities, actions, resources, etc.); runtime components include instantiated versions of the templates and building blocks in a workflow for execution; and, distributed workflows as described herein include context, which relates to a business scenario to which the workflow components are related. Components 246 represent the building block components used to generate a workflow, such as actions. Actions can be used to create an activity, which then can be linked with other activities to build or generate a workflow. Templates 248 represent other building blocks, and may include associations or relationships that relate one or more actions or activities to a context. In one embodiment, templates 248 cannot exist without context; thus, templates 248 can be considered to include context that defines relationships between components 246.

Design-time engine 262 represents one or more modules that enable generation of a workflow and/or its constituent elements. In one embodiment, design-time engine 262 includes modules necessary to provide a development environment in which a developer can generate actions, activities, context (business process or scenario) descriptions, templates, relationships (which may include RTP relationships), resource associations, etc., which are considered the constituent elements of a workflow. Once developed or generated, these elements can be stored in one or more databases, represented as components 246 and templates 248, which are available to instantiate a workflow.

Runtime engine 264 represents one or more modules that enable runtime generation of a workflow. Note that certain templates or components as defined in design-time may be defined based on a business role, rather than based on a specific person. At runtime, the system resolves such dynamic variables and assigns actual values to the dynamic template or generic values of the templates. Runtime engine 264 enables the system to create a workflow specific to a given situation or function, referred to as a business context. Runtime engine 264 either includes context engine 266 or works in conjunction with context engine 266 to determine the context of a workflow to be generated. Context engine 266 can determine the context via annotations such as metadata or system-level descriptions, or from other sources. In one embodiment, the context is determined from an input, such as a request, a document, etc. Runtime engine 264 may be enabled by business logic 244 of backend system 240 and/or via business logic 212 of client device 210. Thus, business logic may include elements of a runtime engine necessary to receive workflow components and render them as a workflow.

Various components described herein may be a means for performing the functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable medium may also include a storage or database from which content can be downloaded. A machine readable medium may also include a device or product having content, stored thereon at a time of sale or delivery. Thus, delivering a device with stored content, or offering content for download over a communication medium may be understood as providing an article of manufacture with such content described herein.

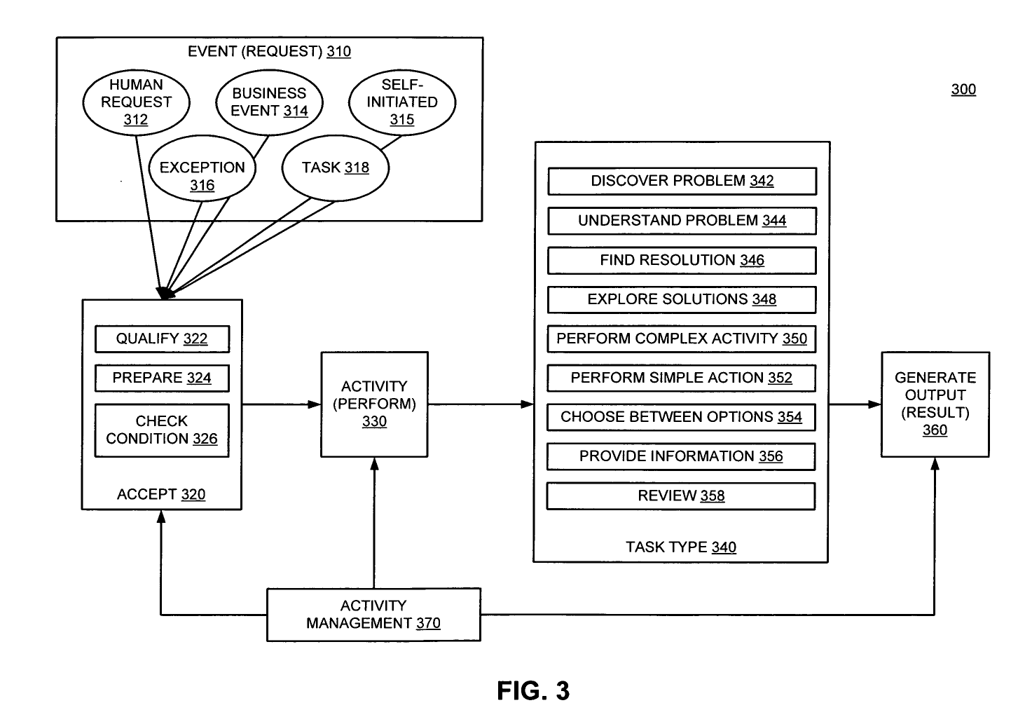

FIG. 3 is a block diagram of an embodiment of a system with an activity management entity that monitors activities generated with a request-to-perform control. System 300 represents an enterprise system according to any embodiment described herein. Specifically in system 300, various components or modules related to events, requests, and actions are described. Event 310 represents a request, which triggers an RTP interaction. Event 310 can be any type of event, and thus, any type of event can be a trigger for an RTP interaction. Examples of events include human request 312, business event 314, self-initiated event 315, exception 316, and task 318. Each illustrated event is intended to be understood in a broad sense, viewed categorically rather than narrowly.

Human request 312 represents requests from other users, for example, as part of a workflow, or as the initiation of a workflow. That is, one user may generate a request of another as part of a distributed workflow. Also, a person (e.g., a supervisor) may request that a particular type of work be accomplished, which could initiate a workflow to accomplish the work. Human request can be received via email, invitations generated from software programs, calendaring, generating a task, etc.

Business event 314 represents any type of occurrence that may take place in a business environment. Examples may include a workflow action that is generated as a result of work completed on a production line, an action generated in response to an online order being placed, etc. Business event 314 may trigger a particular business scenario that generates a workflow, or may provide context that is used in generating a workflow.

Self-initiated event 315 represents an action or a task generated by a user him- or herself. Self-initiated event 315 can be the same as most or any human request 312, but rather than coming from someone else, they are generated by the user that will perform the task. That is, the user is both the requester and the performer in the RTP relationship for that action.

Exception 316 represents any of a number of exceptions that may be triggered in the flow of business. For example, a customer support call may trigger an exception when circumstances warrant providing additional service to the customer, or if the customer becomes particularly uncooperative or upset. Additional examples may include a shutdown or error occurring on the production line, or a disruption to the normal supply chain.

Task 318 represents any other type of event trigger not mentioned already. Task 318 may also be a task of a workflow that generates/triggers another task. For example, workflows move from one task to another, and the transition from one task to the next can operate as an event that triggers a new task.

An event or request 310 is accepted via accept block 320. In one embodiment, certain functions are performed as part of acceptance of event 310. For example, accept 320 may include qualify 322, prepare 324, and/or check condition 326. Qualify 322 refers to specifying the activity required for the request. In one embodiment, negotiation is allowed between the performer receiving the request and the requester. Thus, qualify 322 may also represent the negotiation of terms of the request between the requester and performer. Prepare 324 represents any preparation that is necessary for the activity. Preparation may include obtaining resources, calendaring time, etc. Check condition 326 represents any of a number of verifications that can be performed on the request. For example, conditions for timing conflicts can be checked (e.g., looking at a calendar), making sure that a workload is not too heavy (e.g., too many deadlines within given period of time), etc.

An accepted event is then activity 330. Where event 310 represents the request, activity 330 represents what will be performed to fulfill the request. Activity 330 can be any of a number of different work tasks. Example tasks are illustrated as task type 340, which may include discover problem 342, understand problem 344, find resolution 346, explore solutions 348, perform complex activity 350, perform simple action 352, choose between options 354, provide information 356, and review 358. Task type 340 is merely illustrative, and should not be understood as required or limiting. Note that an activity may include one or more actions, each of which may be modeled. Completing activity 330 will result in an output generated, as illustrated by generate output 360. The output will depend upon the task type, and may be a list, a document, a recommendation, a report, etc.

System 300 includes activity management 370, which represents one or more modules that perform monitoring and other functions with respect to runtime workflows. Activity management 370 can monitor the entire flow of activity from the request (not explicitly shown) to the acceptance, the performance, and the generating the output. Thus, the system can be aware of where a process is, who owns the process, and what is happening with the process. The end result is that processes that have been traditionally hidden from a system level are available via the system for review and status tracking. Additionally, such hidden processes can also be enhanced as system-level resources can be leveraged for generating tasks, checking availability, obtaining resources, etc.

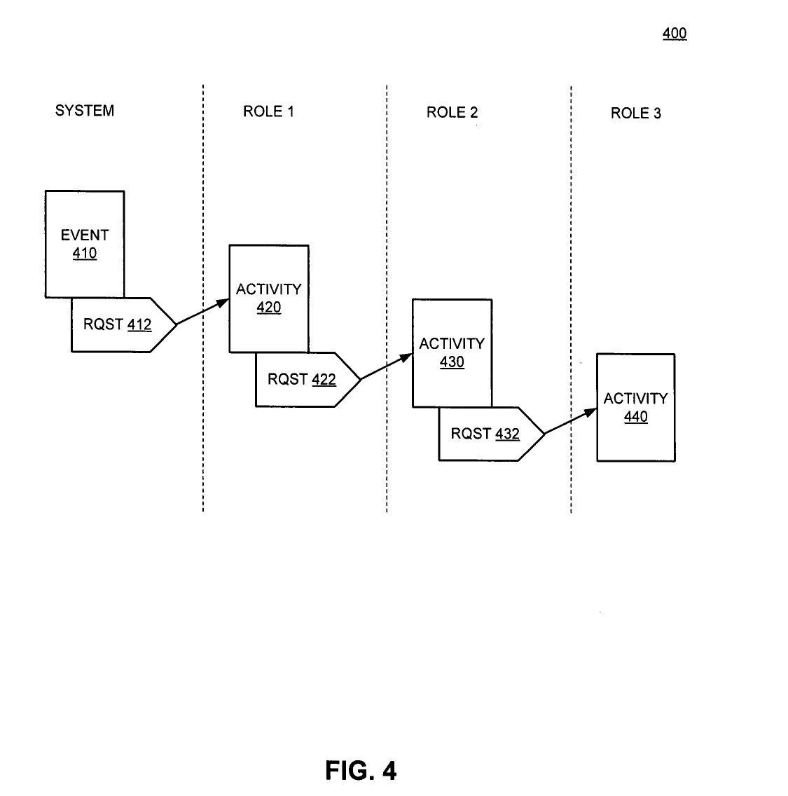

FIG. 4 is a flow diagram of an embodiment of a process for requesting and performing as part of a managed workflow. Flow diagrams as illustrated herein provide examples of sequences of various process actions. Although shown in a particular sequence or order, unless otherwise specified, the order of the actions can be modified. Thus, the illustrated implementations should be understood only as examples, and the process can be performed in a different order, and some actions may be performed in parallel. Additionally, one or more actions can be omitted in various embodiments of the invention; thus, not all actions are required in every implementation. Other process flows are possible.

System 400 includes the “system,” which represents the backend enterprise system, and Roles 1-3, which represent performers and requesters. System 400 is represented as a swim lane view that can enable a developer to associate activities with performers, and relate activities via requests. A sample flow is illustrative. The system may generate event 410, which can be any type of event as discussed above with respect to FIG. 3. Event 410 can act as a trigger for activity 420. Event 410 and activity 420 are related with request 412, which makes the source of the system event the requester, and the user represented by Role 1 as the performer for activity 420.

The Roles can be any type of business role, such as manager, purchaser, lead engineer, system architect, etc. As used herein, a role is a profile of a user that typically performs an activity. With the process flow of system 400 represented in terms of “Role” actors, the resulting process flow can be generic and useful for any of a number of business scenarios, where Roles and actions are variable in a template, and specific when instantiated. Thus, Roles 1-3 may be any of a number of people in any of a number of business scenarios.

Activity 420 of Role 1 can be followed by request 422 for activity 430 of Role 2. Similarly, Activity 430 of Role 2 may be followed by request 432 for activity 440 of Role 3. Requests and activities could continue. Note that in one embodiment, Role 1 and Role 2 may be different roles of the same person. Additionally, Role 1 and Role 3 may be the same role.

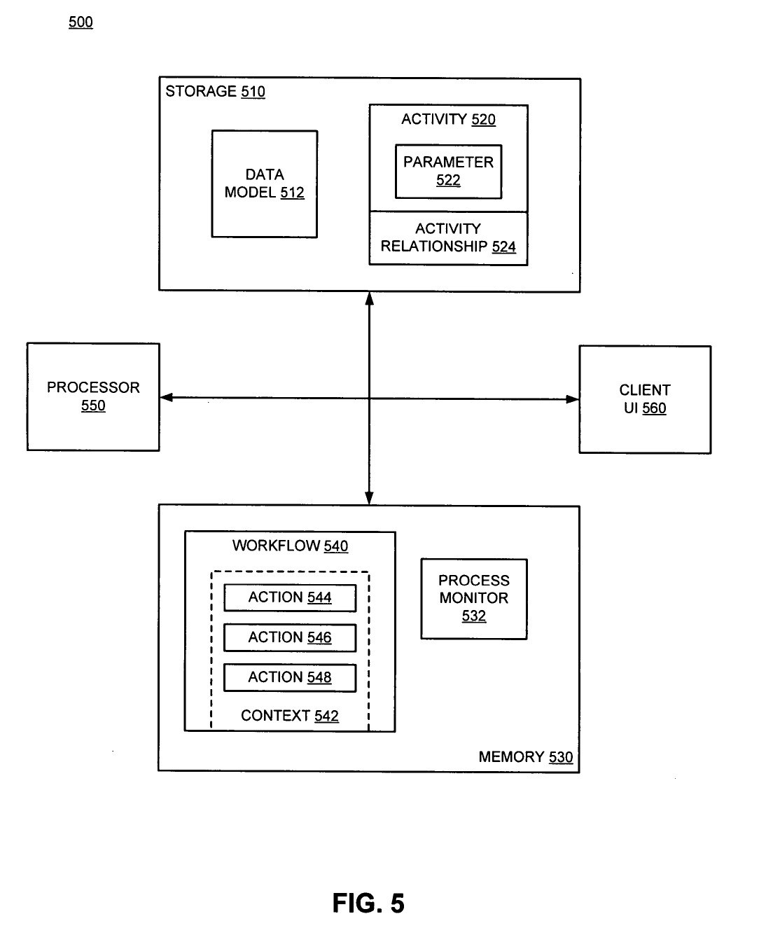

FIG. 5 is a block diagram of an embodiment of a system that generates and monitors a distributed workflow. System 500 represents operative components that store and execute the functional components illustrated in other figures. System 500 includes storage 510, which represents a non-volatile storage device. A non-volatile storage device is one that retains information even in the event of a disruption of power to the device. Storage 510 is typically one or more enterprise databases or storage systems.

Storage 510 includes data model 512, which represents a data model for the system upon which data objects and/or templates can be based. In one embodiment, the data model includes parameters and parameter relationships. In ESA, the data model includes parameters for accessing enterprise services, which provides enterprise functionality for a developed system. Data model 512 can be a lean data model at least because the atomic building blocks of the system are directed to specific functionality and linked with relationships. Thus, a complex data model is not needed to support the distributed workflows as described herein.

Storage 510 includes activity 520, which represents a building block based on data model 512. Activity 520 includes one or more parameters 522, which can allow the activity to be dynamic. In one embodiment, storage 510 also includes activity relationship 524, which can define a relationship of activity 520 to a business scenario, and/or can be a relationship that defines an association to another activity. Note that relationships to other activities may be context-based, and may only exist for an activity in a given business scenario. In one embodiment activity relationship 524 represents a template or a model of a relationship that is not specific to any activity, but can be generated in a runtime environment between an activity and a business scenario, or between and activity and another activity.

Storage 510 is coupled to memory 530, which represents operative memory in a system, and is generally volatile. Memory 530 is for temporary storage of code and data for execution by processor 550. Processor 550 represents one or more processors or processing cores that execute the operations and generally “run” workflows and other programs. In one embodiment, memory includes process monitor 532, which represents a workflow management entity as described herein. Briefly, process monitor 532 can provide system-level functions with respect to workflow tasks (e.g., generating tasks in a user's worklist, generating triggers, alerts, etc., producing reports, storing data, forwarding documents, etc.).

Memory 530 includes workflow 540, which represents a workflow generated from dynamic building block components as described herein. Workflow 540 includes actions 544-548, which may represent individual activities as well as actions of an activity of workflow 540. The actions are related to context 542, and the activities are related to each other as being related to a business scenario of context 542. Additionally, each activity could be related to another via RTP relationships. Workflow 540 represents an instantiated workflow generated from templates in storage 510. The templates are represented by activity 520 and activity relationship 524.

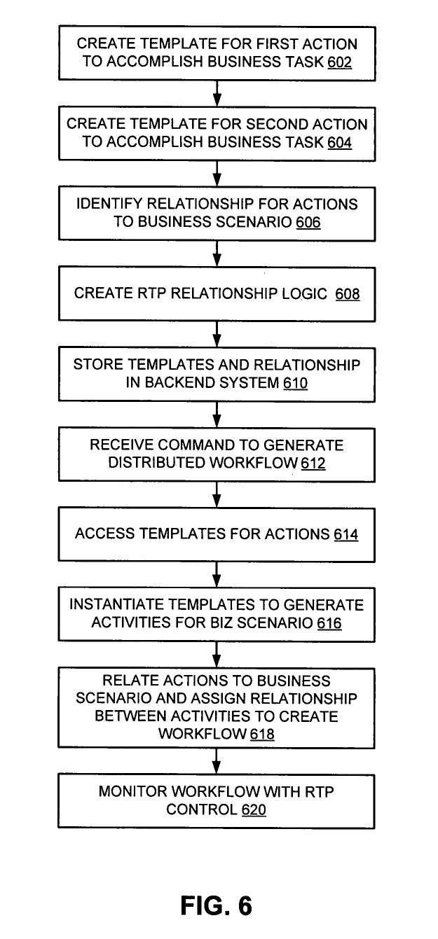

FIG. 6 is a flow diagram of an embodiment of a process for generating a workflow having request-to-perform relationships defining workflow state changes. A developer creates a template for a first action to accomplish a business task, 602. The template can be created from a development environment designed for workflow creation. A developer can also create a template for a second action to accomplish the business task, 604. Note that there is not necessarily any concurrency in the creation of the two templates, and neither template needs to be created with a specific task in mind. The actions may be useful for multiple different business tasks.

In one embodiment, the developer identifies a relationship for the first and the second actions with respect to a business scenario, 606. The developer can create RTP relationship logic that associates the tasks to each other in an RTP relationship, 608. The RTP relationship logic may be parameters entered into a particular template, or metadata or other annotations associated with the template. Relationships may be created as templates as well, which would allow creating specific relationships from generic templates. In one embodiment, creating the RTP relationship logic refers to creating the relationship template.

In one embodiment, the system enables creation of the components in a development environment. The system stores completed action templates and relationship templates in a backend system, 610. The system receives a command to generate a distributed workflow, or a workflow having a dynamically generated or ad hoc flow based on building block components, 612. The command may include parameters or other information with which to instantiate the building blocks as an actual workflow. In one embodiment, the command includes information regarding the context or business scenario for which the workflow is created. In one embodiment, such information is determined from system information (e.g., project name, project type, owner/creator, department, etc.).

In response to the command, the system accesses the templates from storage to generate the actions, 614. The templates are instantiated to generate activities for the business scenario, 616, with the information obtained in the command, or information obtained from the system. The system relates the actions to an identified or determined business scenario and to the activities to generate the activities, and assigns relationships between activities to create a workflow, 618. In one embodiment, the workflow flow control is defined by the relationships assigned between the activities. The system can then monitor the workflow with the RTP control defined between the activities of the workflow, 620.

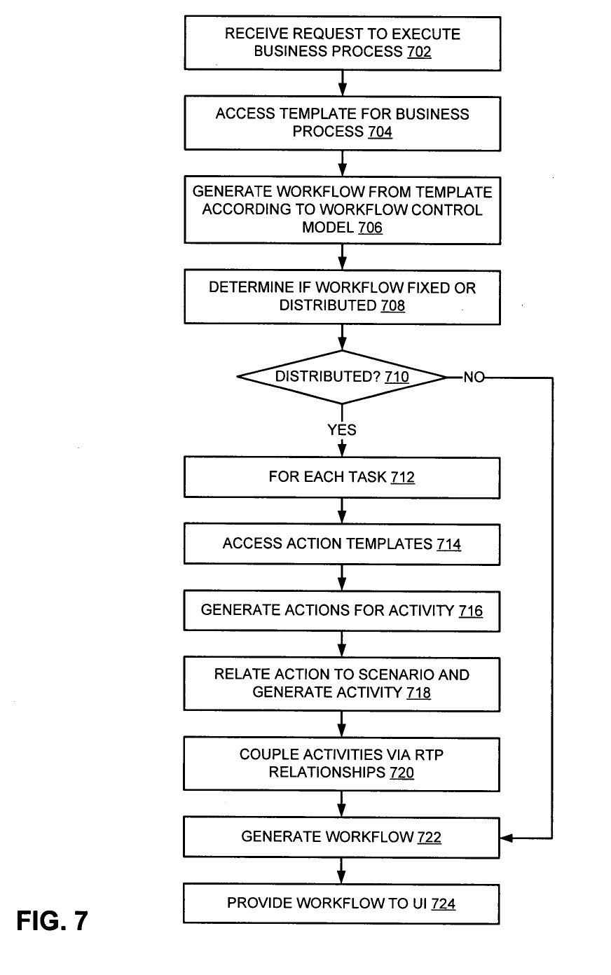

FIG. 7 is a flow diagram of an embodiment of a process for generating fixed or distributed workflows. An enterprise system receives a request to execute a business process, 702. The request to execute the business process can be via initiation of the business process through human (e.g., user) request, or via some other event. The request can be the start of a new workflow, or can be a sub-workflow of an existing workflow (e.g., a workflow that models human interaction on a complex task of a higher-level workflow). The system accesses a template to generate a business process workflow from the template for the business process requested, 704. The system generates the workflow from the template according to the workflow control model, 706. That is, in one embodiment, all workflows within the enterprise system are dynamic or distributed, or created according to a distributed workflow model as described herein. In another embodiment, workflows can be fixed workflows or distributed workflows, and a workflow is created according to whatever model is associated with the workflow.

The system determines if the workflow is fixed or distributed, 708. If the workflow is not distributed, 710, the workflow is simply generated according to the fixed workflow template, 722. If the workflow is distributed, 710, for each task of the workflow, 712, the system accesses templates associated with the actions for an activity to accomplish that task, 714. The templates exist as building block components in the enterprise backend. Activities may have different numbers of actions. The actions are generated from the templates to create an activity, 716. Each action is related to the business scenario associated with the requested business process, and the one or more actions can generate an activity, 718. The activities are also coupled to other actions via RTP relationships, 720. The workflow is then created, 722. From one perspective, a distributed workflow is generated via the associating of the actions with the business scenario and defining the transitions between the actions (via the assigned RTP relationships). The generated workflow is provided to a UI for interaction with a user that will carry out one or more actions of the workflow, 724.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

1. A method for modeling a business process, comprising:
generating a first activity of a workflow from one or more work action templates of a backend enterprise system, the generating including providing a parameter to associate the first activity with a business scenario;
generating a second activity of a workflow from one or more work action templates of the backend enterprise system, the generating including providing a parameter to define a relationship of the second activity with a business scenario; and
relating the first and second activities via a request-to-perform relationship.

2-5. (canceled)

6. The method of claim 1, wherein relating the activities comprises:
relating human-to-human actions via the request-to-perform relationship.

7-21. (canceled)

22. A method for modeling a business process, comprising:
instantiating from a template in a backend enterprise system a fixed workflow having a series of multiple tasks, at least one of the tasks being a complex task having multiple activities, each task of the fixed workflow being a state of the fixed workflow, where state changes in the fixed workflow are based on a transactional control;
instantiating from a template in the backend enterprise system a distributed workflow for the complex task, the distributed workflow having an activity context containing the multiple activities and resources associated with the complex task, each activity being a state of the distributed workflow, where state changes in the distributed workflow are based on a request-to-perform control; and
monitoring the fixed workflow and the distributed workflow with the backend enterprise system.

23. The method of claim 22, wherein generating the fixed workflow comprises:
generating an enterprise resource planning (ERP) workflow from a database of ERP workflows.

24. The method of claim 22, wherein the transaction control comprises completion of a task that represents a transaction of the fixed workflow.

25. The method of claim 22, wherein the request-to-perform control comprises generation of a request for performance of an activity by another entity.

26. A system comprising:
a nonvolatile storage device having stored thereon a template that defines a fixed workflow having a series of multiple tasks, at least one of the tasks being a complex task having multiple activities, each task of the fixed workflow being a state of the fixed workflow, where state changes in the fixed workflow are based on a transactional control; and a template that defines a distributed workflow for the complex task, the distributed workflow having an activity context containing the multiple activities and resources associated with the complex task, each activity being a state of the distributed workflow, where state changes in the distributed workflow are based on a request-to-perform control; and
a memory device coupled to the nonvolatile storage device in which to instantiate the fixed workflow and the distributed workflow from the templates, the memory device further including a workflow monitor to manage the fixed workflow and the distributed workflow, including documenting the state changes in the fixed workflow and the state changes in the distributed workflow.

27. A method for modeling a business process, comprising:
generating a business scenario description defining human interactions to accomplish a business purpose;
defining the business scenario description as multiple activities to be distributed to various performers;
generating an activity description defining an activity as one or more actions to be accomplished by a single performer;
associating one or more activity descriptions to the business scenario description;
associating one or more resources with the business scenario description, the resources to be passed to and returned from activity descriptions of the business scenario description; and
associating one or more resource with the activity description, the resources to be passed to and returned from the actions of the activity description.

28. The method of claim 27, wherein generating the activity description comprises:
generating an activity description applicable to multiple different business scenarios; and
storing the activity description as a reusable business activity building block for generating business process workflows.

29. The method of claim 27, wherein associating the one or more resources with the activity description comprises:
defining one or more of a document, a business object, or an enterprise service as a resource for the business activity.

30. The method of claim 27, further comprising:
generating an action description applicable to multiple different business activities; and
storing the action description as a reusable business action building block for generating business process workflows.

31. The method of claim 27, further comprising:
relating the activity description to another activity description to generate a workflow for the business process.

32. The method of claim 31, wherein relating the activity descriptions comprises:
relating human-to-human actions via a request-to-perform relationship.

33. The method of claim 27, further comprising:
monitoring the one or more actions of the business activity via a backend enterprise system.

34. The method of claim 33, wherein monitoring one or more actions via the backend enterprise system comprises:
storing results generated from execution of the actions.

35. The method of claim 33, wherein monitoring one or more actions via the backend enterprise system comprises:
assigning a task to a different performer in response to performance of an action.

36. The method of claim 35, wherein assigning the task to the different performer further comprises:
transferring ownership of the business process in the backend system to the different performer via a transition from the activity to assigned task.

37. The method of claim 27, wherein monitoring one or more actions via the backend enterprise system comprises:
capturing human-to-human interaction as part of the business process.

38. An article of manufacture comprising a machine readable medium having content stored thereon to provide instructions to cause a machine to perform operations including:
generating a business scenario description defining a work context of human interactions to accomplish a business purpose, including defining activities to be distributed to various performers to accomplish the business purpose;
generating an activity description template defining a business activity for a performer, the activity description including a parameter configurable to define a one or more resources associated with the business activity;
generating a work action template defining work to be executed by the performer to accomplish a distributed activity;
generating an association between the action template and the activity description template, and an association between the activity description template and the business scenario description; and
storing the business scenario description, the activity description template, the action template, and the associations in an enterprise system.

39. The article of manufacture of claim 38, wherein the content to provide instructions for generating the templates comprises content to provide instructions for
generating reusable building block components from which a distributed workflow is created.

40. The article of manufacture of claim 38, wherein the content to provide instructions for generating the business activity template further comprises content to provide instructions for
generating the business activity template with associated metadata that defines a relationship of the business activity to the business scenario.

41. The article of manufacture of claim 38, further comprising content to provide instructions for
assigning a request-to-perform relationship between two business activities.

42. The article of manufacture of claim 41, wherein the content to provide instructions for assigning the request-to-perform relationship between the business activities further comprises content to provide instructions for
assigning an event trigger as a request.

43. The article of manufacture of claim 42, wherein the content to provide instructions for assigning the event trigger comprises content to provide instructions for
assigning as a request a human request or a self-initiated event.

44. The article of manufacture of claim 42, wherein the content to provide instructions for assigning the event trigger comprises content to provide instructions for
assigning as a request a business event, a system exception, or a task.

45. The article of manufacture of claim 38, wherein the content provides instructions for generating a distributed workflow for a business process associated with the business purpose.

46. The article of manufacture of claim 45, wherein the content provides instructions for generating a distributed workflow for all tasks of the business process.
